(19) United States
(12) Patent Application Publication
(10) Pub. No.: US 2005/0125831 A1
(43) Pub. Date: Jun. 9, 2005

(54) System and method for broadcasting entertainment related data

(76) Inventor: Donald E. Blanchard, Marietta, GA (US)

Correspondence Address: GEORGE R. REARDON, 3356 STATION COURT, LAWRENCVILLE, GA, 30044, US

(21) Appl. No.: 10/996,984

(22) Filed: Nov. 23, 2004

Related U.S. Application Data
(60) Provisional application No. 60/527,027, filed on Dec. 4, 2003.

(51) Int. Cl. H04N 7/16; G10H 7/00; A63H 5/00; H04N 7/173

(52) U.S. Cl. 725/81; 725/62; 725/63; 725/86; 725/61

(57) ABSTRACT

This invention relates generally to a system and method for broadcasting and retailing entertainment-related data. More particularly, this invention relates to a system and method for broadcasting and retailing entertainment-related data using wireless fidelity, Wi-Fi, technology. Wi-Fi technology is also known as 802.11x, where “x” can vary, such as, but not limited to, 802.11b, 802.11g, etc.

This application claims priority to provisional application 60/527,027, dated Nov. 24, 2003, which is incorporated herein in its entirety.

### FIELD OF THE INVENTION

This invention relates generally to a system and method for broadcasting and retailing entertainment-related data. More particularly, this invention relates to a system and method for broadcasting and retailing entertainment-related data using wireless fidelity (Wi-Fi) technology. Wi-Fi technology is also known as 802.11x, where “x” can vary, such as, but not limited to, 802.11b, 802.11 g, etc.

### BACKGROUND OF THE INVENTION

Buying recorded entertainment, such as, but not limited to, music and videos, traditionally has been a rather simple and straightforward process. For example, a customer may visit his local music store and buy the latest CD or hit song from his favorite artist. Recent developments have significantly improved access to entertainment inventory by enabling customers to purchase or obtain music on-line, such as through an Internet web site, or by participating in legitimate music or file-swapping networks.

However, present methods and systems suffer from several drawbacks. First, whether a purchase is made in-person or on-line, the customer must know either the title of the song or CD, or the name of the artist. Without this information the customer will be hard-pressed to find what he or she is looking for. Second, buying music can be time-consuming. The customer usually has to travel to the music store, search for what he is looking for, and hope that it is in stock. If the song or CD is not available, the customer will have to visit other stores. On-line orders are also time-consuming. The customer has to know the name of the particular song and/or musician that he/she is looking for to log-in to a particular web site or network, hope that the song or CD is in stock, and then wait for the download to take place or for the item to arrive in the mail.

Similar challenges exist for DVDs of movies, television shows, concerts and the like. These and other problems exist.

One example of these problems involves the downloading of very large files such as music videos and full-length movies, since full-length movies require approximately 600 to 800 Mb to download. If more than a handful of people try to download a movie file program simultaneously, the usual or traditional method of making a movie available from a central server would typically freeze up the system or the downloads would become so slow consumers would give up and stop the process.

Also, as a file of data (music, games, music videos, movies, etc.) becomes popular, content providers and/or download fulfillment houses experience soaring bandwidth-usage bills—since their Internet service provider often charges on a per-Mb-downloaded basis. Current methods to solve this problem using the Internet include compression and swarming.

Compression involves using one or more algorithms or other methods to reduce the size of the data file to a much lower amount of Mb while still retaining the files' audio/visual appeal. One example is DivX, another is MPEG(x), (where “x” denotes a number of versions) whose compression rates claim to be very effective with no loss in visual or audio detail. For instance, DivX claims to take a 600-800 Mb movie file and compress it to only 60-80 Mb.

Swarming, used by BitTorrent and others, uses downsteam bandwidth to spread the costs of distributing the files. (Swarming may mean anything that uses an integrated web of transmission including BitTorrent, Chord, Peer-to-Peer and Mesh Networks, among others). Swarming allows a large number of people to get the same file much more quickly, since the load is not relegated to one server. Generally, these methods use peer-to-peer as a distribution model to greatly reduce time for downloading of complicated, high volume data. By “borrowing” chunks or pieces of data already downloading on others' computers, swarming dramatically speeds up the downloading process.

The description below of the method of use is based on generally accepted industry protocol:
An Internet computer user requests a download of a very large file (for instance, music, album, music video, movie)
Files are broken up into smaller pieces of data according to how many active down-loaders there are. There may be hundreds, if not thousands, of active down-loaders downloading one particular file.
The smaller pieces of data are distributed to the active down-loaders.
A tracker, also known as a central directory, tells the Internet computer user's computer where to find each piece, whether on the central server or on other computers (peers) that have already downloaded some or all of the pieces or a combination of these. Where each piece of the file is pulled from and downloaded from the Internet will depend on the capacity each computer has and the load each computer is dealing with at the time of the request
The software downloads the least prevalent piece on the network first, thus making this process more useful to its peers.

The BCC uses BitTorrent as follows:
Internet Computer User#1 decides to download an episode of a TV show and contacts the central web server to find out the address of the tracker server.
The tracker tells Internet Computer User#1's computer how many chunks the program has been divided into and who already has some of the chunks.
Internet Computer User#1's computer discovers that Internet Computer User#2 and Internet Computer User#3 have begun to download the program, but neither has completed the process.
The computer determines which chunks they don't have and goes to the seed server to download them so that Internet Computer User#1 has something that Internet Computer User#2 and Internet Computer User#3 want.
Internet Computer User#1's computer then begins to download the remaining chunks from Internet Computer User#2 and Internet Computer User#3 and reciprocates by uploading Internet Computer User#1 's new chunk to them. This leaves the seed server free to serve different programs to other users. The seed server only needs to deliver the whole of the episode of a TV show once.

Previous attempts to facilitate the downloading of music includes U.S. Pat. No. 6,423,892, issued to Ramaswamy, which discloses an MP3 files downloading method which involves searching MP3 content sites to display MP3 files, such that a desired MP3 file is downloaded to wireless MP3 player. Another attempt to facilitate the downloading of music includes U.S. Pat. No. 6,647,417, issued to Hunter et al., which discloses a music distribution system transmitting music with an anti-piracy identification tag via satellites to user stations according to customer selections using an interactive screen selector.

Other attempts to connect users with entertainment media include the Nokia 7700, the first mobile phone that can receive digital TV transmissions, using the DVB-H standard, visual radio using the Nokia 7700 Media Device, where listeners receive a FM sound signal plus images and text on the LCD handset display screen. Additionally, several establishments have created stations at which users may select and create a personalized CD. Also, in-theatre digital broadcasts of excerpts and interview footage from upcoming albums have been done to build purchasing interest among viewers.

While these and other approaches are a good start, improvements are needed to facilitate connecting the user with the user's desired entertainment media. Therefore, it is an object of the present invention to provide a system and method of broadcasting and retailing entertainment-related data that overcomes these and other obstacles.

The foregoing patents and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### SUMMARY OF THE INVENTION

The aforementioned and other objects were achieved by the present invention which is a system and method for broadcasting and retailing entertainment-related data.

Additional objects and advantages of the invention will be set forth in part in the description which follows, and in part will be obvious from the description, or may be learned by practice of the invention. The objects and advantages of the invention will be obtained by means of instrumentalities in combinations particularly pointed out in the appended claims.

The invention pertains to a method of providing entertainment media to users using a source of broadcasting of entertainment data, a receiver of that data and software that senses the presence of the broadcasted data and alerts the user of the receiver of the presence of the broadcasted data. The invention further pertains to using communication, ordering and fulfillment software and networks to provide entertainment data to users.

The invention further pertains to simulcasting entertainment information to receivers at a venue. Venues in which the invention can be used are, but are not limited to, movie theaters, retail establishments, concerts, and the like.

### BRIEF DESCRIPTION OF THE DRAWINGS

The accompanying drawings illustrate a complete embodiment of the invention according to the best modes so far devised for the practical application of the principles thereof, and in which:

FIG. 1 shows the first portion of the logic flow for one embodiment of the invention

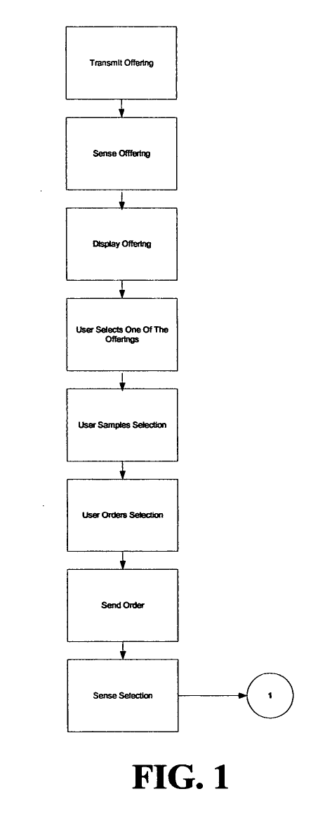

FIG. 2 shows the second portion of the logic flow for one embodiment of the invention.

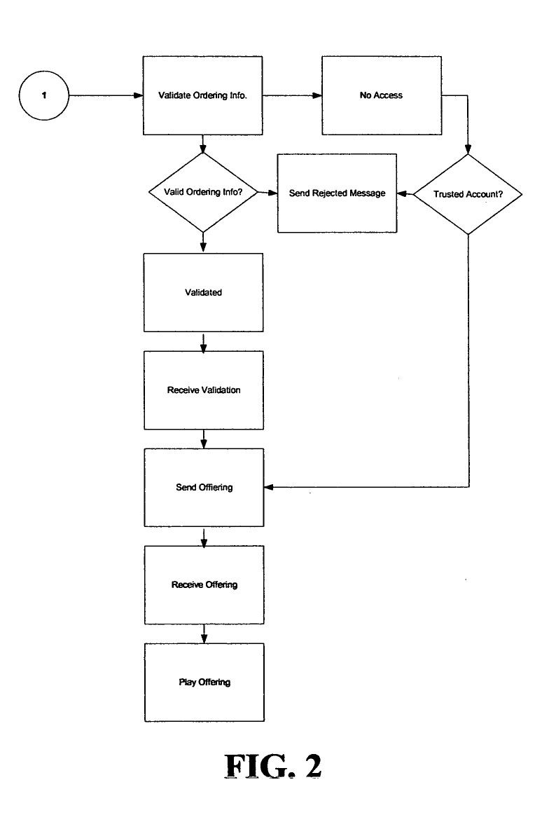

FIG. 3 shows the process for installing the software for use with one embodiment of the present invention.

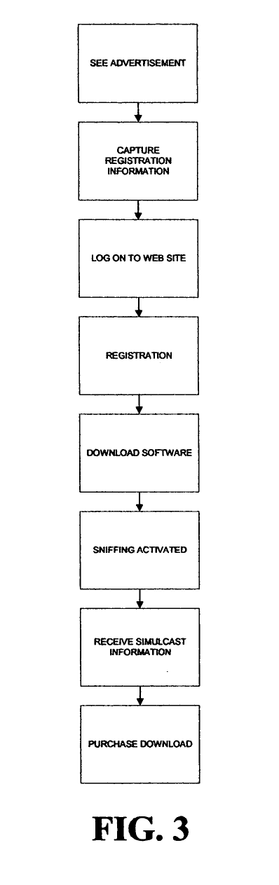

FIG. 4 shows one financial model for use with the present invention.

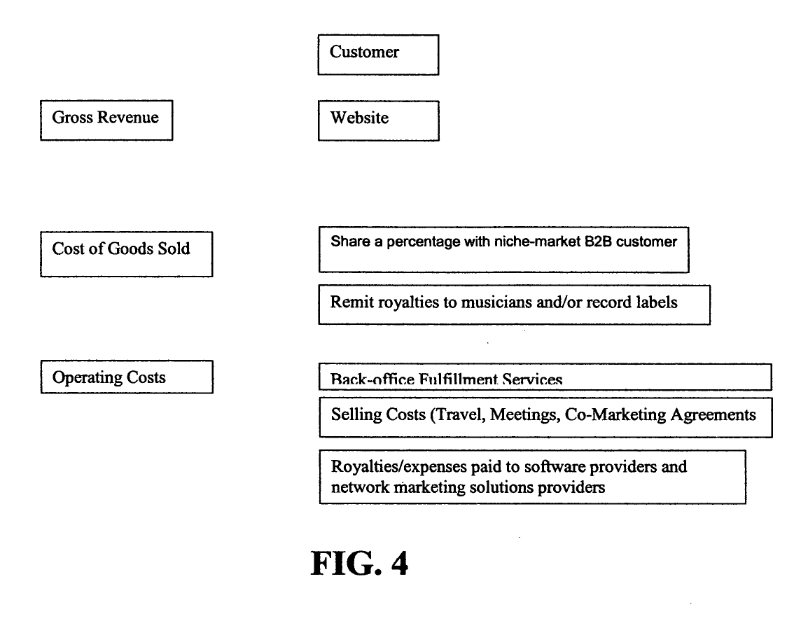

FIG. 5 shows the process flow in a movie theater venue.

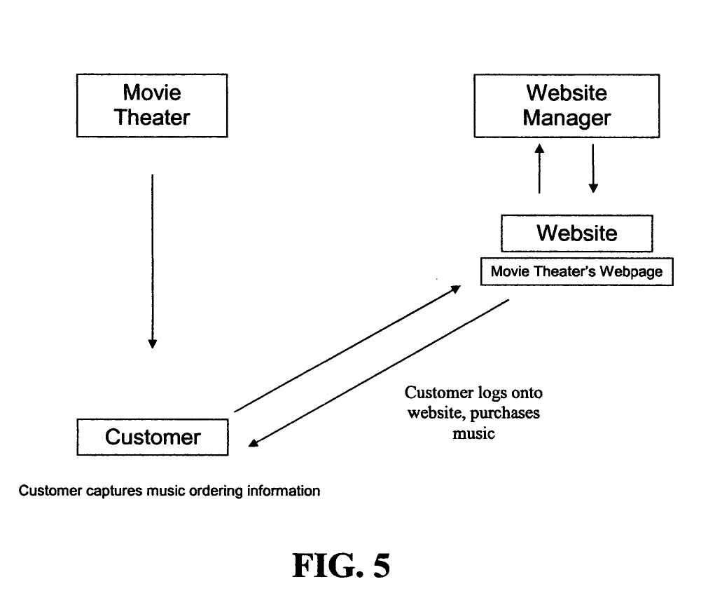

FIG. 6 shows how information is shared over the internet using swarming technology.

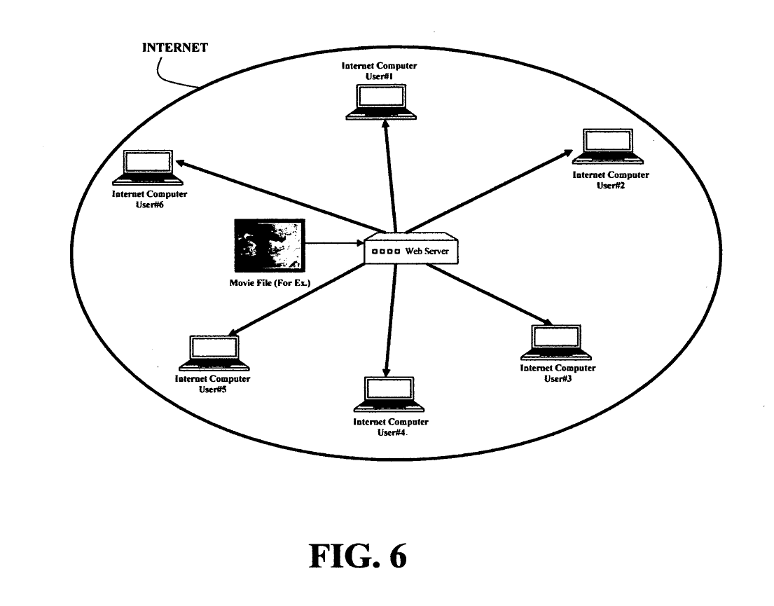

FIG. 7 shows a combination of file compression with swarming technology.

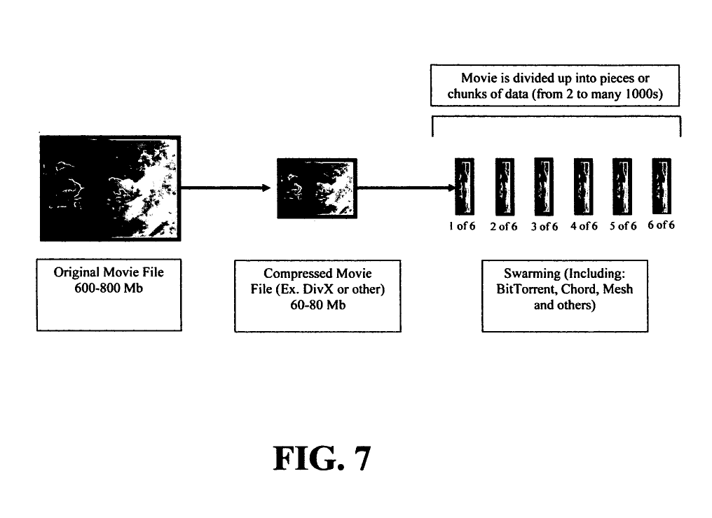

FIG. 8 shows swarming technology used according to the present invention.

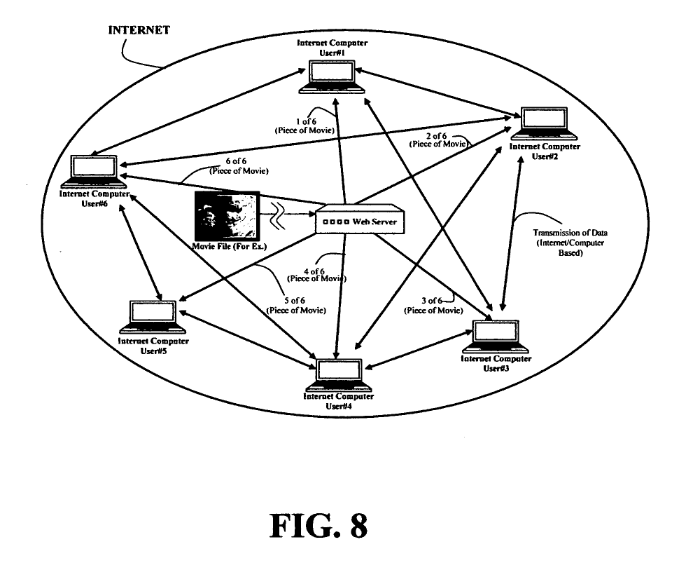

FIG. 9 shows swarming technology used within a cinema according to the present invention.

FIG. 10 shows swarming technology used within a cinema using surrogates for client Wi-Fi enabled devices, according to the present invention.

FIG. 11 shows further detail of using swarming technology within a cinema according to the present invention.

### DETAILED DESCRIPTION OF THE INVENTION

Reference will now be made to the present preferred embodiments of the invention. The drawings show aspects of the invention.

The present invention is described in relation to various systems and methods for broadcasting and retailing music using Wi-Fi. Nonetheless, the characteristics and parameters pertaining to various embodiments the systems and methods described herein may be applicable to transactions associated with other types of content and/or industries.

In one embodiment, the present invention may broadcast and retail music through Wi-Fi technology. Wi-Fi technology may enable wireless connection to a network, such as the Internet, for example. Wi-Fi may consist of an access point connected to the network and a wireless card, or equivalent, operably connected to the PC, laptop, PDA device, or any other device that is to access the network. The wireless card and the access point wirelessly transmit and exchange data, permitting the user of the PC, laptop, or PDA device, for example, to access or surf the network Usually, the PC, laptop, or PDA device must be within a predetermined range of the access point, for example, within 100 meter indoors or 300 meters outdoors. Wi-Fi enabled devices may transmit and receive information through air, walls and ceilings, thus eliminating the need to fully hard-wire buildings.

Various embodiments of the systems and methods described herein may comprise or include a Wi-Fi broadcast module that broadcasts information data about a song that is presently being heard or played over a broadcast system or method, such as a department store PA system, for example. Information data may comprise, for example, the title of the song or album, and the name of the musical group or artist. Other information data is possible. In one embodiment, the information data is broadcast simultaneously with the song being played. In another embodiment, information data is broadcast in a continuous loop. According to one embodiment, Wi-Fi broadcast module may be preprogrammed with a particular song list, or may obtain information data about each song as it plays, for example. In another embodiment, Wi-Fi broadcast module may comprise computer-readable code. Wi-Fi broadcast module may comprise, be installed on, be connected to, or be associated with a particular music source, such as a PA system, radio station, or any other system or method that broadcasts music, for example.

Various embodiments of the systems and methods described herein may also comprise or include a reception module for receiving, processing, and presenting information data from the Wi-Fi broadcast module, for example. In one embodiment, the reception module receives information data corresponding to a particular song being heard or played over a broadcast system or method, such as a department store PA system, for example. In another embodiment, the reception module may receive information data from the Wi-Fi broadcast module. In one embodiment, reception module may comprise computer-readable code. Reception module may comprise, be installed on, be connected to, or be associated with a PC, laptop, PDA device, or another device able to receive and process data, for example.

In one embodiment, the reception module may present to the user of the device on which it is installed, for example, information data relating to the particular song being played or broadcast. In one embodiment, the information may be presented in graphical or textual form on a screen associated with the particular device, for example. In one embodiment, information data is presented in real time. In another embodiment, a specially designated cookie may be pre-installed on a customer's Wi-Fi enabled device, enabling the reception module to receive and display information data in a customized manner, for example. In another embodiment, the customer may view particular icons corresponding to whatever song is currently playing, such as the song's title and/or name of the artist, for example. Other presentation features are possible.

Reception module may further comprise a purchasing module for enabling the user to purchase the particular song being played or broadcast. For example, a user (or customer) walking into a department store having a PA system connected to a Wi-Fi broadcast module may receive information data corresponding to the particular song being played or broadcast, including, for example, the purchase price of the song. The information may be presented on the customer's Wi-Fi enabled device's screen, for example, and may further include a purchasing icon for enabling the customer to purchase the song. In one embodiment, the purchasing module may enable the customer to purchase and download the song directly to a Wi-Fi enabled PDA, for example. In another embodiment, the customer may be connected to a web site where he may purchase and download music, for example. In another embodiment, the downloaded file may contain an encryption key for security purposes, such as a cookie that embeds customer identification information in the digital data, for example. This way, for example, the customer may securely purchase music without having to visit a music store, log on to the Internet, locate a music web site, find and select the desired music, or go through other aspects of the traditional ordering process. Moreover, the customer does not have to know the title of the song, CD, or the name of the artist.

In another embodiment, Wi-Fi broadcast module (and/or reception module) may push out to the customer a “shopping basket” icon, for example, showing the customer his purchases and offering him the opportunity to “buy now” or add to his shopping list. The customer may then click on the icon to see his purchases of songs listed by name of song, group or album, for example, and/or to add a particular song to the list. In another embodiment, the customer may elect to pre-set the icon to automatically connect to a particular web site to download the music, or he may do so manually.

Reception module may further comprise a sensor module that senses the presence of Wi-Fi communication. In one embodiment, sensor module may comprise sniffer software. In another embodiment, a software patch may be installed on the customer's Wi-Fi enabled device to immediately identify a song playing and display information related to the song. In another embodiment, sensor module may pick up the broadcast of song information from any digital radio station broadcast that is embedded in their “sub-band” broadcast, for example.

Reception module may further comprise a transfer module for transferring downloaded or purchased song(s) to another person's device. In one embodiment, the person may be a second tier customer or buyer. In another embodiment, the transfer module may share or transfer the song's icon and/or information data, for example, to another device which may or may not contain a reception module. If the second tier buyer, for example, does not have an account or is not recognized (e.g., the device does not have a reception module installed), then a cookie that accompanies the icon and/or information data may request that the new customer set-up an account, for example.

In one embodiment, the new customer may be connected to a web site where he may download the appropriate software, for example.

In another embodiment, the customer may send the information about the song by electronically exchanging the icon for the particular song. The second tier customer then has the song's information and price and he can download it directly to his Wi-Fi enabled device, or be connected to a particular web site, for example, just as the previous customer.

In another embodiment, information data may be transferred, for example, but not limited to, via an infra-red, Wi-Fi BlueTooth, ultra wide band signal, and the like.

The system and method of the invention may also comprise a tracking module for tracking all purchases and transfers. In this embodiment, the invention may monitor and/or track the purchasing or downloading of music, for example. In one embodiment, tracking information may be used to distribute monies to all participating electronic music merchants with bonuses paid out according to down-line power, for example.

In another embodiment, a customer may receive affinity rewards based on the amount of purchases he effectuates through down-line customers, e.g., other customers who have previously received or purchased songs from or through the customer, for example. The affinity rewards may include fan materials such as posters, tickets to concerts, music album discounts, for example.

In another embodiment, an administrator of the invention may enter into a co-promotion agreements with airlines or hotels (or other entities and industries) to offer affinity rewards from these venues as well, for example.

In another embodiment, a cookie, or equivalent technology, may indicate or identify a new customer that was referred to (e.g., given a music icon and/or information data) by the first customer. The relationship between the two music customers may also be recorded or tracked.

In another embodiment, the music purchased by and or downloaded to a second tier customer may contain an encryption key for security and identification purposes. A cookie, for example, may embed the new customer's identification in the digital information for future identification. This new customer identification number may be associated with the original customer's identification, for example, so that subsequent sharing and purchasing may be properly identified and complete up-line or down-line tracking made possible.

Utilizing the sub-band of IBOC (In-Band, On-Channel) broadcasting that may broadcast data—the name of the song, the name of the album, the name of the musician(s) and the name of the radio station. As technological process is made, the data may come to include compressed data representing the entire song, music-video or album. The invention can capture this data, independent of playing the radio broadcast OR while simultaneously playing the radio broadcast and then use the data to facilitate a purchase of music.

The system entails a method of simultaneous reading and broadcasting a song's identification information via Wi-Fi. Alternatively the system may receive a radio broadcast signal (on a sub-band of IBOC (In-Band, On-Channel) that offers information about a song—the name of the song, the name of the album, the name of the musician(s) and the name of the radio station. Music merchants described above may include radio stations.

This method of commerce can also be utilized by nightclubs and other music venues to sell music as a branded music merchant.

This system is capable of simultaneously broadcasting a song's identification information via Wi-Fi. Some other digital broadcasting method can be used to promote the sale of music videos, ring tones, screen savers, video clips, movie trailers, or virtually any entertainment media that can be digitized, through movie theaters during the actual display of music video songs to the audience before the beginning of a movie.

Additional non-music uses include oral presentations, written presentations, white papers, etc. given at speeches during conferences, etc.

One embodiment of the process for broadcasting embedded information is as follows:
Venue owner inputs into the system retail prices for types of music sold
Venue owner programs the system to broadcast a venue-specific location code
System reads programmed information
System reads embedded identifying information from music sound tracks
System simulcasts song identifying information along with price/venue-specific location code
The end user responds (See customer-level operation below)
System sends end user's response to contracted fulfillment house
System routes responding end user to venue owner's private-label website
Venue owner's private-label website is communicated to end user
System automatically logs in responding to end user
System recognizes existing or new customers
System directs new customers to registration web page
System processes orders
System fulfills digital purchase
System records origination of end user purchase
System credits all parties related to digital purchase
System operates customer relationship management (CRM) promotion and reporting

One embodiment of the process for end user operations is as follows:
The end user becomes aware of the service
End user registers
End user downloads software to Wi-Fi enabled device
End user activate software
Wi-Fi enabled device detects transmission of information
End user selects and reviews information
End user purchases entertainment media
Wi-Fi enabled device receives purchased information
End user plays information on Wi-Fi enabled device
End user recalls ordering information
End user shares ordering information with another Wi-Fi enabled device

One embodiment of the process for end user registration is as follows:
The end user sees an (electronic or physical) advertisement for the service
The end user captures information about registration
Broadcasted website address is sent to end-user in the form of a pop-up advertisement, email, v-card, etc.
   Optionally a website address is keyed in by end-user
   Optionally, a website address is scanned or bar-code read
The end user logs onto the system's website
The end user performs registration procedures
   The end user sees a brief demo of all the systems applications
   The end user selects one or more of the following applications:
      Digital Entertainment Purchases, e.g. Music (singles/albums), music videos, video clips, screensavers, ring tones, games, etc.
      Information/Public Service
      In-Venue Shopping Search Agent (Shopping Bot)
      Customer Service Comment Reporting
      Product Registration
   The end user supplies contact information
   The end user supplies payment (e.g., credit/debt card) information
   The end user determines purchasing/downloading options:
      Immediately upon capturing buying information, automatically log onto the Internet and execute the order payment and fulfillment (download)
         alternatively, purchase and download automatically upon end-user's next Internet log-on
         alternatively, manually perform step-by-step purchase and download of the order while the end user is logged onto the Internet

One embodiment of the process for downloading of software applications is as follows:
Upon registering, the end user initiates a downloading of the system software applications. For instance: Market Basket, Music Icons and Order Execution “Cookie”
   The Market Basket is installed on the end user's Wi-Fi enabled device screen
      The systems Market Basket software application includes:
         The ability to receive and store, for order execution, any System Music Icon that is dragged to the Market Basket folder.
         The ability for the Market Basket to change in some noticeable way in order to communicate to the end user that there are one or more items stored in the Market Basket
      The Music Icon (digital purchase) is installed on the end user's desktop
         The Music Icon software application includes:
            The ability to change the displayed Music Icon in some noticeable way in order to communicate to the end user that the system has received broadcasted information
            The ability to receive and display broadcast information such as name of a song, price, for instance.
            The ability of end users to click open the Music Icon and obtain additional information received from broadcast sources which may include one or more of the following:
            Name of the Band
            A brief audio playback (15 seconds, for instance)
            Additional available purchases, for instance:
            The entire album
            Ring Tones
            Other digital entertainment
            Other promotions
            The ability to be directly linked to the Order Execution Cookie
            The ability to communicate with the Order Execution Cookie and display to the END USER any or all Music Icons collected.

One embodiment of the process for the order execution cookie is as follows:
The Order Execution Cookie is installed on the end user's Wi-Fi enabled mobile device operating system.
The system's Order Execution Cookie software application includes:
   A direct link to the Market Basket to collect process information related to selecting and purchasing digital entertainment located (stored) in the end user's Market Basket.
   The ability to record and store a history (for display within the end user's Music Icon sub-menu of additional information) of all digital entertainment or Music Icons dragged and dropped into the Market Basket, whether or not the customer subsequently bought the digital entertainment or not.
   The ability that allows the end user to display the complete history of Music Icons dragged and dropped into the Market Basket and to edit (add sub-headings, delete, add, etc.) the list of music.
   The ability to automatically link with the website owned by the broadcaster of system information and consummate music and other digital entertainment purchases.
   An assigned Personal Customer Identification Number (P-CIN)
      For example: Personal—Customer Identification Number (P-CIN) 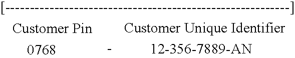
         Customer PIN=Customary Identification Code for conducting secure transactions.
         Customer Unique Identifier=A commercial identifier designed to ID a particular customer without disclosing private information.
         An assigned Abbreviated Customer Identification Number (A-CIN)
            For example:
            Abbreviated Customer Identification Number

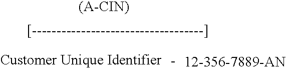

Recognizing (Sniffing) Broadcast Information
The END USER approaches a location where the system simulcasts buying information as well as order facilitation information for various digital entertainment products that relate to what is simultaneously being exhibited by the location
   The buying information may be for one or more of the following products (not limited to):
      Audio
      Music Videos
      Song Singles
      Albums
      Compilations
      Song Lists
      Ring Tones
      Audio/Video
      Screensavers
      Video Clips
      Movie Clips
      Movies
      Electronic Games
      Digital Games
      Anything That Can Be Digitized

The Entertainment Icon dynamically changes to alert END USER that the location is system-enabled and has picked up (sniffed, received) one or more broadcasted signals indicating available purchases or information by:
Changing shape or alternatively changing color or alternatively rotating (If more than one broadcast signal is sniffed, the Icon may change to represent the various offerings: For example: if the END USER walks into a store and a system-equipped store is offering a sale on apparel and offering to sell music that is currently being heard, the END USER's desktop Icon begins to rotate (which indicates the END USER is in the presence of a system enabled broadcaster) and the Icon may change after each rotation to show music for sale (with a rotating “M” for example) and show apparel for sale (by with a rotating “A,” for example)

Rather than making one Icon to display for all possible offerings (music, games, clothing sales, information, public service alerts, customer service comment cards, etc.), one option is to use multiple Icons or a combination of Icons and scrolling or ticker-tape style displays.

Immediately displaying buying information for what the END USER is currently hearing and/or seeing.
For music, for example, buying information may include, but not be limited to:
   Name of the song, for example
      Name of the album, for example
      Price (venue owner's posted price)
      Sample music clip
      Ring tone
Optionally, the END USER can click on the rotating or changing icon and display additional information
Order facilitation information is not displayed, but is also captured by the system's Order Execution Cookie and includes:
   Location/vendor unique dentifier
   Assignment of a unique END USER identifier (personal customer ID number)

Selecting/Purchasing/Fulfillment of Digital Information
The END USER selects the music, for instance, by clicking and dragging the Music Icon (entertainment icon) to END USER's desktop Market Basket.
END USER's music buying information is stored in the Market Basket for immediate or later purchase, fulfillment (downloading) and sharing, based on the pre-set registration preferences noted above.

Paying for the Order
The END USER's digital purchase is executed by any number of commercially acceptable e-commerce payment platforms that currently exists.
   For illustration, some basic steps include:
      The order and payment information is accepted
      he payment information is validated
      The order is placed
      Order confirmation is sent to the Wi-Fi enabled device

Fulfillment of Digital Purchase
The digital purchase or information request is fulfillment by any of several commercially available and industry acceptable methods through third-party fulfillment services (fulfillment houses, data warehouses, etc.)

Storing Digital Information
The Music Icon and music purchasing information is stored along with the music on the END USER's mobile digital device.
The system's order execution cookie stores in the END USER's desktop Market Basket a direct link to a list (a history) of all Music Icons dragged to the Market Basket whether the END USER has actually purchased the music or not.

Recalling, Reviewing and Sharing Music Purchasing Information
At any time, the END USER can recall, review, share and, of course; delete one or more Music Icons and the associated music purchasing information.
The END USER double-clicks the Music Icon, opening up the folder to view additional information
The END USER selects Music History to view all Music Icons previously dragged to the Market Basket (with associated music purchasing information).
The END USER double-clicks on any particular Music Icon and sees music purchasing information
The END USER clicks to see additional information
The END USER clicks on a particular Music Icon to play and listen to a short excerpt of one song of interest
The END USER executes a purchase of the music, and/or forwards (shares) the Music Icon (with music purchasing information automatically attached) to one or more END USERs.
The end user can store the music on the device and later transfer the music to other devices.
The END USER can send the Music Icon and music purchasing information to another END USER by any of a number of generally accepted methods including, but not limited to:
   Infra-Red
   E-mail
   Wireless
   Etc.
The end user stores music download directly on the device and/or wirelessly transfers music to other devices for storage and playback, or non-wirelessly transfers music to other devices for storage and playback (for example, a home entertainment central server).
Embedded in the Music Icon or alternatively in the music purchasing information is a basic instruction set which includes:
An identifier that determines whether or not the receiver of the Music Icon has the prerequisite system software application installed
An abbreviated customer identification number (without the customer PIN number) that also is able to be daisy-chained to other customer identification numbers. For example:

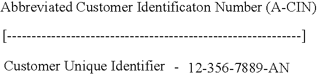

A software application that finds and attaches the A-CINs in a daisy-chain fashion of all END USERs that receive a shared Music Icon and who, in turn share a Music Icon with another END USER. For instance:

| | | |
|---|---|---|
| Customer | Daisy Chained A-CINs | Original Purchase |

| | |
|---|---|
| Original Customer | |
| (END USER) | |
| ID: 12-356-7889-AN | 12-356-7889-AN |
| Shares With Customer | |
| #2 (END USER2) | |
| ID: 21-823-1121-BT | 12-356-7889-AN- |
| | 21-823-1121-BT |
| Who Shares With Customer | |
| #3 (END USER3) | |
| ID: 59-458-9913-ZA | 12-356-7889-AN- |
| | 21-823-1121-BT- |
| | 59-458-9913-ZA |

The Establishment (e.g., a cinema)
The movie theater plays music videos before the start of the movie.
Continuously, during each music video, the system's system broadcasts the theater ID number and the music video icon showing the name of the music video, the name of the band, and the price for purchasing the music video.

The User
A person logs onto the Internet and locates the system's website.
The interested user registers his demographics (name, address, etc.) and enters his credit card information.
The user downloads the system's SongSniffer and suite of software apps.
Optionally, the user can specify whether he would like to have all music he selects to be automatically purchased or for a reminder to show him the list of music he has selected before final purchase confirmation.
Optionally, the system can broadcast the music information along with a music sample so that the user can click the music icon of a song he has moved to his MarketBasket and the song sample will play to remind him of the song.
Optionally, the system can broadcast a full download of the entertainment data, e.g., a full movie.
The system's software app, in the form of two desktop icons—SongSniffer and MarketBasket, is displayed on the user's Wi-Fi enabled electronic device (PDA, PVP, music player, etc.)
The user enters a system-equipped movie theater and watches a music video. He likes the music video and wants to know the name of the song and the band. He looks at his electronic device and notices ghe system's SongSniffer icon has changed to an icon representing the music video and it instantly lists the music information (the name of the song, name of the band and the price of the music video).
The user clicks or moves the music video icon to his desktop MarketBasket. The system's tracking software immediately assigns and attaches to the music icon's music information, the user's ID number.
The user watches another music video while in the movie theater, sees that his SongSniffer icon has changed to an icon representing this second music video and again, the user clicks or moves the music video icon to his desktop MarketBasket (where he collects music to be purchased)
The next time the user logs onto the Internet, The system's software recognizes that the user's MarketBasket has songs-to-purchase. The software instantly connects to the system's client website (in this case the movie theater's branded website), tallies the order and immediately processes the order and downloads the music video file. The music video file is stored on the system's play list.
The user enjoys the music video and decides to share it with his friend, who currently doesn't have the system's system installed on his electronic device.
From the user's system play list folder, the user transfers the music video icon to his friend's electronic device. The music video icon along with the system's software application “cookie” recognizes that his friend doesn't have the system. The software application politely asks the friend if he would like purchase the music video and open an account with the system.
The friend logs onto the Internet and the software application “cookie” automatically calls up the system's new accounts webpage that runs an instructional presentation showing all of the benefits to being registered.
The friend registers his demographics (name, address, etc.) and enters his credit card information. The system's tracking system immediately assigns and attaches to the music icon's music information an extended ID number that includes the user's ID and his friend's ID number. (As a song is distributed from the original purchaser (user) to many friends through sharing, the system's tracking system tallies all purchases and all relationships. The system follows the entire line of purchasers.)
Adapting certain network marketing relationship tracking technologies, The system's tracking system keeps track of all purchase histories and the relationships of any shared music videos.
Through an outsourced third-party downloading service, the system receives account status information; debits the accounts of the system clients such as the movie theater for their agreed to revenue sharing amount; and distributes any royalty payments owed to any record labels and artists. The system's tracking system matches the relationship histories to the outsourced downloading records and keeps track of the total purchases the user has made. More importantly for marketing, the system also keeps track of the total purchases that are a result of peer-to-peer sharing. The system generates affinity rewards to heavy purchasers and heavy sharers.
For example, the system recognizes that the original “user” purchased a music video and then shared it with three of his friends. His three friends purchased the music video and shared it with nine of their friends who in turn shared it with twenty-seven of their friends. Eventually, this active original “user” is directly or indirectly responsible for 1,200 music video purchases. The system's affinity rewards program rewards the movie theater with additional revenue, and The system rewards the original “user” and many of his friends with free tickets to concerts, free movie tickets, etc.
Optionally, the “establishment” can be a retail, restaurant or coffee establishment; alternatively the establishment can also be a radio station, concert venue, nightclub, sports arena, conference center, among other venues.
Optionally, the “user” can be a customer of: music including—single songs, albums, ring-tones, music videos; sports including—video or audio highlights, complete game videos; conference proceedings including—conference white papers, video and audio recordings of speeches, movies (whole or selected portions), etc.
Optionally, the electronic device can include among other devices: laptop computers, notebook computers, tablet computers, PDAs, PVPs, PVRs, MP3 and other music players and smart phones.

One embodiment of the invention pertains to combining compression technology with swarming to distribute entertainment data to Wi-Fi enabled devices within a venue. Combining these first two steps solves many of the downloading issues for Internet-based downloading of files.

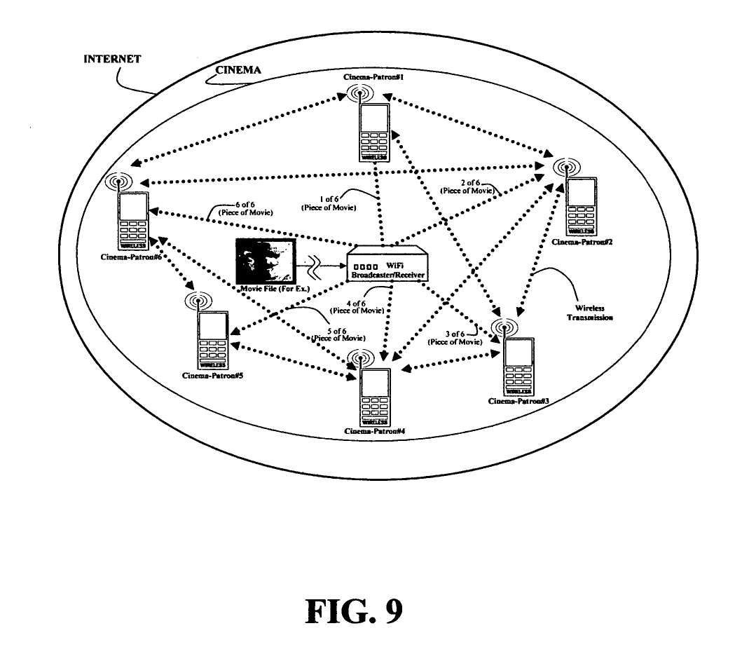

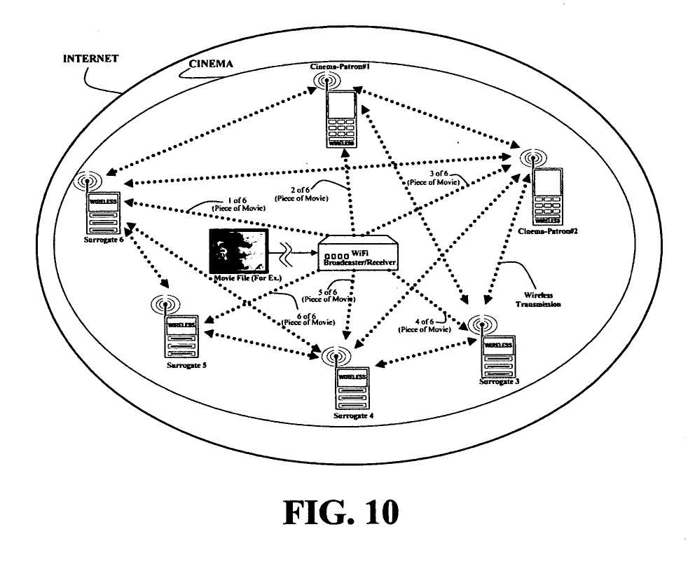

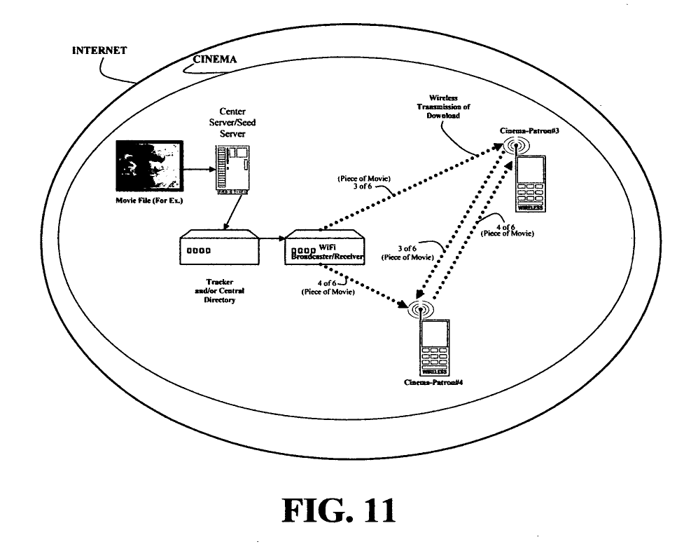

The system and method for downloading music, music videos, and movies (among others) consist of the below integration of methods and technology (see FIG. 11 which offers more detail of FIG. 9 & FIG. 10). This system and method uniquely combines one or more commercially acceptable methods of swarming and compression with a wireless network in order to successfully accomplish downloads of very large files at a venue, e.g., cinemas, theaters, concert halls, concert venues, sporting arenas, etc.
Compressing an audio or an audio/visual file (among others) to reduce the amount of Mb, thus making storage and transmission of the file easier, faster and less costly.
Breaking up the compressed file into smaller “chunks” using one or more commercially available means including, for instance, BitTorrent, Swarming, Chord, Peer-to-Peer, Mesh Networks, etc.
Installing wireless broadcasting/receiving nodes within a closed setting where the patrons who may have something in common to download wirelessly, for instance—cinemas, theaters, concert halls, concert venues, sporting arenas, etc. (For purposes of illustration we are using “cinemas;” however, cinemas may be interchanged with any number of words to depict a gathering of people who want or need downloaded entertainment, information, and instructions—theaters, concert halls, concert venues, sporting arenas, etc.)
Integrating the above functions to communicate to and download/upload files to wireless devices over a wireless network e.g, Wi-Fi (802.11x).
Using surrogates for peers to provide a simulated swarming-of-peers that accomplishes trading of data (or downloads) quickly and efficiently even when there only a few patrons interested or capable of using our method at the time of requests, as shown in FIG. 10.

An example of delivery of very large data files to patrons of a cinema by this embodiment is as follows:
CinemaPatron#1 decides to download a soundtrack of the movie he is watching while at the cinema. (The use of the label “CinemaPatron” is for purposes of illustration and also denotes patrons of any venue-setting including, but not limited to, theaters, concert halls, concert venues and sporting arenas).
CinemaPatron#1 picks up his wireless mobile device and makes contact with the cinema's (or some other 3^{rd} party's) central web server.
The mobile device and software applications automatically find out the address of the tracker server and make all necessary connections.
The tracker server tells CinemaPatron#1's wireless mobile device how many chunks the program has been divided into and who, within the cinema, already has some of the chunks of the soundtrack.
Through this embodiment's unique software application and system configuration, the CinemaPatron#1's wireless mobile device discovers that CinemaPatron#2 and CinemaPatron#3 have begun to download the program, but neither has completed the process.
The wireless mobile device works out which chunks they don't have and goes to the cinema's (or some other 3^{rd} party's) seed server to download them so that CinemaPatron#1 has something that CinemaPatron#2 and CinemaPatron#3 want (see FIG. 9)
To speed up the downloading process, this embodiment uniquely designs, configures and installs one or more wireless mobile devices that act as surrogates mimicking CinemaPatron#4 through CinemaPatron#100 (for example) in case there are not enough CinemaPatrons actively downloading at the moment. While FIG. 9 shows surrogate wireless mobile devices as 5 separate units, the surrogates are not limited to 5 and the number of surrogates may vary by venue and application. Also, many surrogates may be housed in one unit or many units.
CinemaPatron#1 through #3 decide to download (see FIG. 10)
CinemaPatron#1's wireless mobile device then begins to download the remaining chunks from CinemaPatron#2, CinemaPatron#3, etc. and reciprocates by uploading CinemaPatron#1's new chunk to them. This leaves the seed server free to serve different programs to other users. The cinema's seed server only needs to deliver the whole movie soundtrack once.
Note: While FIG. 9 and FIG. 10 show some mobile devices not communicating to others—the figures were drawn to omit some connections in order to make the drawing less cluttered. There are no limitations as to how many of the wireless mobile devices communicate with each other, as long as there are at least two wireless mobile devices.

The above description and drawings are only illustrative of preferred embodiments which achieve the objects, features and advantages of the present invention, and it is not intended that the present invention be limited thereto. Any modification of the present invention which comes within the spirit and scope of the following claims is considered part of the present invention.

Other embodiments, uses and advantages of the present invention will be apparent to those skilled in the art from consideration of the specification and practice of the invention disclosed herein. The specification and examples should be considered exemplary only.

1) A method of wirelessly distributing entertainment media within a venue comprising:
a) Transmitting entertainment information using Wi-Fi technology;
b) Detecting the transmission of said entertainment information on a Wi-Fi enabled device;
c) Alerting the user of said Wi-Fi enabled device of the presence of said entertainment information;
d) Responding to said alerting;
e) Reviewing said entertainment information;
f) Ordering entertainment media corresponding to said entertainment information;
g) Receiving said entertainment media;
h) Playing said entertainment media on said Wi-Fi enabled device; and
i) Transferring said entertainment media to another device.

2) The method of claim 1, further comprising:
a) Recalling said entertainment information;
b) Reviewing said entertainment information; and,
c) Sharing said entertainment information with another Wi-Fi enabled device.

3) The method of claim 2, further comprising using a combination of file compression and swarming technology to distribute entertainment media.

4) The method of claim 3, wherein said Wi-Fi enabled device is a PDA.

5) The method of claim 3, wherein said Wi-Fi enabled device is a wireless phone.

6) The method of claim 3, wherein said Wi-Fi enabled device is a combined PDA and wireless phone.

7) The method of claim 3, wherein said Wi-Fi enabled device is a PVP.

8) The method of claim 3, wherein said venue is a movie theater.

9) The method of claim 3, wherein said venue is a retail establishment.

10) The method of claim 3, wherein said venue is a concert.

11) The method of claim 3, wherein said entertainment media is audio.

12) The method of claim 3, wherein said entertainment media is video.

13) The method of claim 3, wherein said entertainment media is video and audio.

14) A method of wirelessly distributing entertainment media within a venue comprising:
a) Transmitting entertainment information using Wi-Fi technology;
b) Detecting the transmission of said entertainment information on a Wi-Fi enabled device;
c) Alerting the user of said Wi-Fi enabled device of the presence of said entertainment information;
d) Responding to said alerting;
e) Reviewing said entertainment information;
f) Ordering entertainment media corresponding to said entertainment information;
g) Receiving said entertainment media;
h) Playing said entertainment media on said Wi-Fi enabled device;
i) Transferring said entertainment media to another device using a combination of file compression and swarming technology;
j) Recalling said entertainment information;
k) Reviewing said entertainment information; and,
l) Sharing said entertainment information with another Wi-Fi enabled device.

15) The method of claim 14, wherein said Wi-Fi enabled device is from the group comprised of PDA, smart phone, PVP, wherein said venue is from the group comprised of a movie theater, a retail establishment, a concert, and wherein said entertainment media is from the group audio, video, screensaver, ring tones, games.
